(19) United States
(12) Patent Application Publication
(10) Pub. No.: US 2004/0055156 A1
(43) Pub. Date: Mar. 25, 2004

(54) Safety razor

(75) Inventor: William R. Brown JR., Peabody, MA (US)

Correspondence Address: PATENT AND TRADEMARK COUNSEL, THE GILLETTE COMPANY, 800 BOYLSTON STREET, BOSTON, MA, 02199, US

(73) Assignee: The Gillette Company

(21) Appl. No.: 10/254,351

(22) Filed: Sep. 25, 2002

(51) Int. Cl. B26B 21/14

(52) U.S. Cl. 30/34.1; 30/50

(57) ABSTRACT

The present invention relates to multi-blade shaving apparatus comprising: a handle; a head body pivotably supported by said handle at a pivoting action centerline; a plurality of shaving blades (preferably 3 blades) located in said head body, said plurality of shaving blades extending parallel to each other; and an additional blade located in said head body, said additional blade being located in a plane at an angle of 60° to −120° to a plane of said plurality of shaving blades (preferably 85° to 95°), and said additional blade being located at a same side of said head body as the plurality of shaving blades relative to the pivoting action centerline. Preferably, said plurality of shaving blades and said additional blade are identical in shape when secured to the shaving apparatus. It is also preferred that said plurality of shaving blades and said additional blade are identical in shape when secured to the shaving apparatus and that there is a means for rotating the shaving apparatus to enable different of said plurality of shaving blades to be in contact with skin of a user dependent upon rotation of said handle.

### BACKGROUND OF THE INVENTION

1. Field of the Invention

This invention is concerned with safety razors and more particularly relates to a safety razor blade unit including at least one blade with a sharp cutting edge that is moved across the surface of the skin being shaved by means of a handle on which the blade unit is carried. The blade unit may be mounted detachably on the handle to enable the blade unit to be replaced by a fresh blade unit when the blade sharpness has diminished to an unsatisfactory level. Alternatively, the blade unit can be fixedly attached to the handle with the intention that the entire razor be discarded when the blade or blades have become dulled. Detachable and replaceable blade units are commonly referred to as shaving cartridges. Safety razors are also referred to as multi-blade shaving apparatus throughout.

2. Brief Description of Related Art

In recent years there have been marketed blade units including a plurality of blades, in particular having two, and more recently three, blades arranged with their cutting edges extending parallel to each other for contacting the skin between guard and cap surfaces also provided by the blade unit. The performances of these blade units is enhanced by certain guard and cap structures, such as an elastomeric strip on the guard with a series of upstanding fins and a shaving aid strip included in the cap for depositing a substance, e.g. a lubricant, on the skin surface during shaving. For the most part these known blade units produce very satisfactory results. However, due to the presence of more than one blade and the particular guard and cap structures, the blade units generally contact the skin over a relatively large area and some shavers experience difficulties in shaving areas in tight corners where access by the razor is restricted by facial features such as under the nose and near the ears.

With a view to enabling the blade unit to follow the skin contours in the performance of a shaving stroke, it is well known to mount the blade unit for pivotal movement about an axis that extends parallel to the cutting edges of the blades. On the whole the pivotal movement of the blade unit relative to the handle facilitates the use of the razor by making the shaving efficiency less sensitive to small changes in handle orientation with respect to the skin as the blade unit performs a shaving stroke. It has been found that some shavers can experience difficulty, due to pivoting of the blade unit, in obtaining an optimum positioning of the blade unit against the skin when attempting to shave areas in tight corners. Also, there is a tendency for users of safety razors to wish to press the blade unit of a razor harder against the skin when trimming longer hairs, for example the sideburns, and the pivotal movement of the blade unit can sometimes be perceived to act to thwart such attempts to increase the force with which the blade cutting edges are urged against the skin.

In view of the foregoing considerations there is a need for a safety razor blade unit which is better able to satisfy the requirements of all consumers with respect to trimming longer hairs and shaving skin areas to which razor access is restricted.

There have been proposals to provide safety razors that provide increased versatility as to the manner in which they may be used for shaving. In U.S. Pat. No. 5,199,173 for example there is described a safety razor with an arched blade unit with blades providing cutting edges at both the concave and convex sides, the blade unit being selectively rotatable on the razor handle to bring the concave or convex side into an operative shaving position. GB-A-2179286 proposes a razor with two blade units pivotally mounted on a handle independently of each other and positioned on the handle to facilitate shaving the left and right sides of the face. U.S. Pat. No. 2,439,909 describes a safety razor that, rather than having blades with rectilinear cutting edges, has fixedly mounted on the razor handle a curved foil with slots that are inclined to the shaving direction in which the foil is moved across the skin during shaving and have sharpened cutting edges, there being in addition a further slot with a sharp cutting edge extending laterally across the foil behind the inclined slots, and this cutting edge associated the additional slot being intended for hair trimming purposes. WO-A-91/01204 also describes a razor having a blade unit equipped foil blade provided with sharp-edged apertures for shaving, the blade unit being held stationary relative to the razor handle during normal shaving, but being pivotally adjustable to expose a sharp cutting edge at the leading edge of the foil for hair trimming purposes. None of the prior art proposals are suitable for adoption in the known multi-bladed safety razor blade units intended to perform pivotal movements during shaving, with a view to improving the ability of such blade units to shave areas to which access is restricted and/or to trim longer hairs.

### SUMMARY OF THE INVENTION

In accordance with one aspect of the present invention there is provided a multi-blade shaving apparatus comprising: a handle; a head body pivotably supported by said handle at a pivoting action centerline; a plurality of shaving blades (preferably 3 blades) located in said head body, said plurality of shaving blades extending parallel to each other; and an additional blade located in said head body, said additional blade being located in a plane at an angle of 60° to −120° to a plane of said plurality of shaving blades (preferably 85° to 95°), and said additional blade being located at a same side of said head body as the plurality of shaving blades relative to the pivoting action centerline. Preferably, said plurality of shaving blades and said additional blade are identical in shape when secured to the shaving apparatus. It is also preferred that said plurality of shaving blades and said additional blade are identical in shape when secured to the shaving apparatus and that there is a means for rotating the shaving apparatus to enable different of said plurality of shaving blades to be in contact with skin of a user dependent upon rotation of said handle.

With such a blade unit the skin contact area spanned by the guard, blades, and cap at the upper face can be relatively large and similar to the corresponding area of known multi-bladed shaving cartridges currently marketed, whereas the skin contact area spanned by an auxiliary guard, blade and cap at the rear face is substantially smaller and facilitates use of the blade unit for shaving skin areas constricted by protruding facial features adjacent thereto. The angle between the tangential planes ensures that the blade edge or edges at the rear face are held safely clear of the skin surface when shaving with the blade edges at the upper face of the blade unit and vice versa.

At least the first guard preferably includes an elastomeric strip with upwardly directed projections, such as a series of fins or tubes, as known per se, for contact with the skin. Also, at least the first cap preferably includes a lubricating strip, also as known per se.

### BRIEF DESCRIPTION OF THE DRAWINGS

The currently most preferred form of blade unit embodying the invention combines all the aspects and preferred features mentioned above and is described in greater detail below with reference being made to the accompanying drawings in which:

FIG. 1 is an isometric view of the blade unit shown from the rear;

FIG. 2 is a cross-section through the blade unit;

FIG. 3 shows the blade unit mounted on a handle providing a multi-blade shaving apparatus of the present invention; and

FIG. 4 is a sketch illustrating a multi-blade shaving apparatus equipped with the blade unit in a position for trimming hair in front of an ear of the razor user.

### DETAILED DESCRIPTION OF THE INVENTION

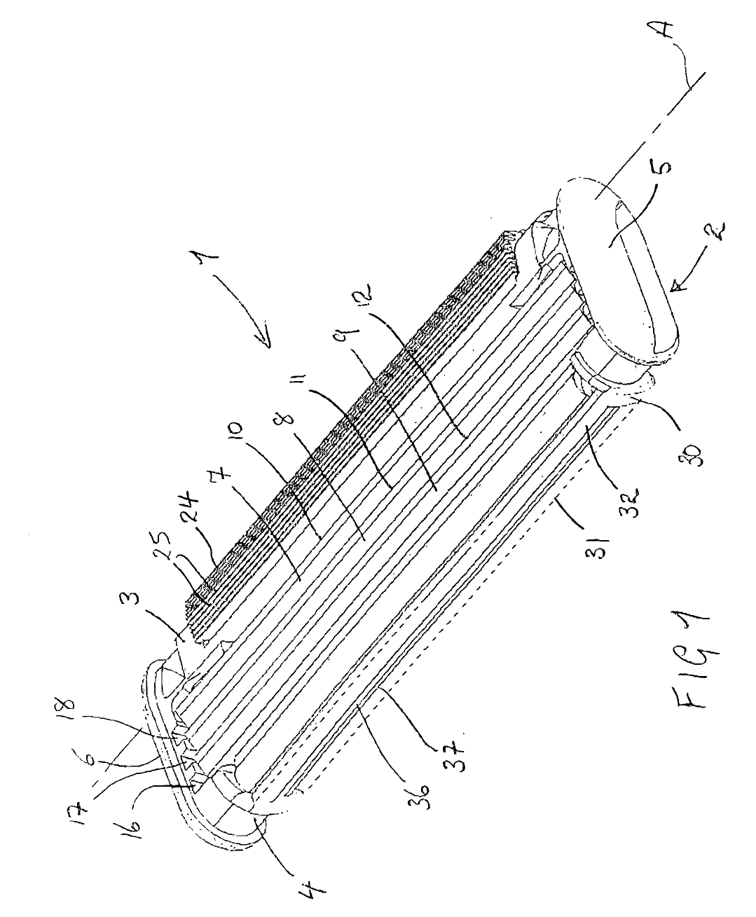

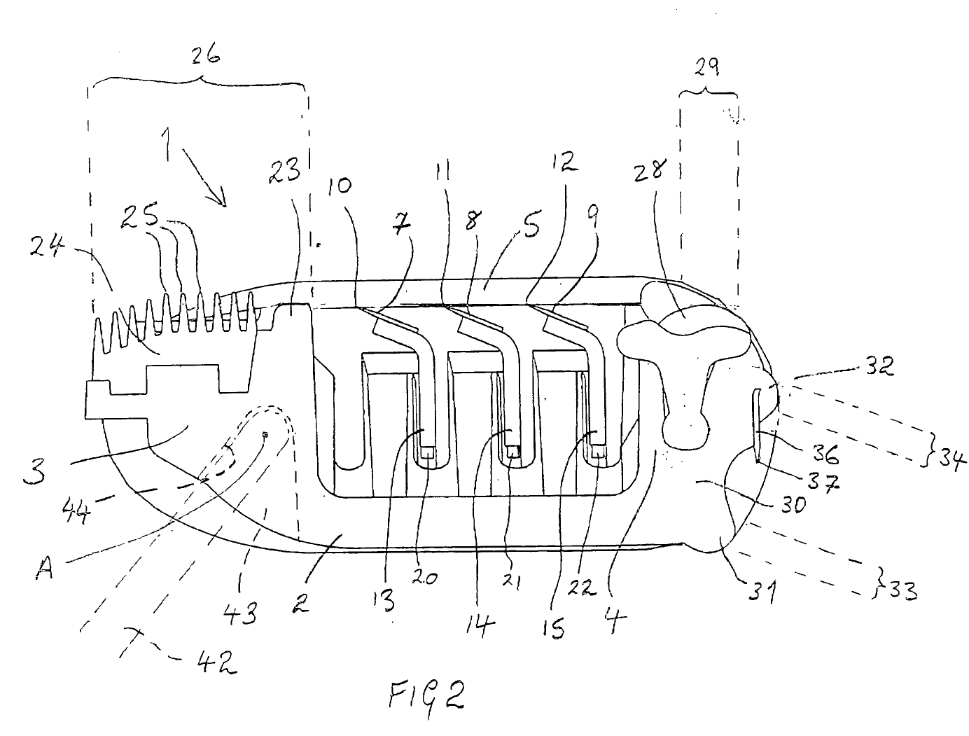

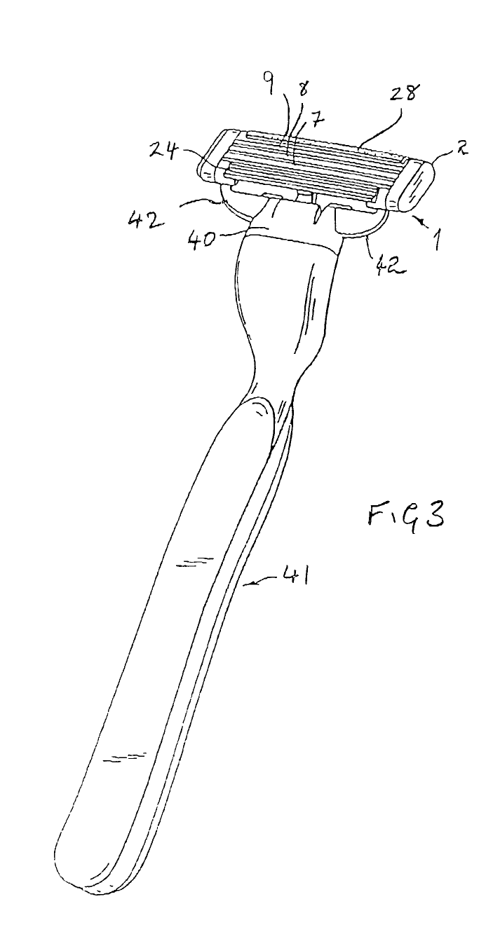

There is illustrated in FIGS. 1, 2, 3 and 4, a safety razor blade unit 1 comprising a plastic housing or head body 2 including front and rear members 3, 4 interconnected by integral frame ends 5, 6. Mounted in the frame between the front and rear members 3, 4 are three blades 7, 8, 9 with parallel forwardly facing sharp cutting edges 10, 11, 12. The blades are carried by elongate blade supports 13, 14, 15 the ends of which are guided in slots 16, 17, 18 in the frame ends. In a manner known per se the blades 7, 8, 9 are capable of moving independently of each other under forces imposed on the respective blades during shaving. Springs 20, 21, 22 act on the undersides of the blade supports 13, 14, 15 and provide return forces opposing downward displacements of the blades 7, 8, 9. The front frame member 3 defines a backstop 23 with an upper surface for contact with the skin during shaving, and carries an elastomeric guard strip 24 shown to have a series of parallel upstanding fins 25 also for contact with the skin during shaving. Other elastomeric strip surface configurations could be provided in addition to or instead of the fins 25. The elastomeric strip 24 and backstop 23 together define a first guard surface 26 for contact with the skin. The frame member 3 also defines the front face of the blade unit. The rear frame member 4 carries on its upper side a lubricating strip 28 which defines a first cap surface 29 for contacting the skin behind the blades 7, 8, 9 when shaving the skin with these blades. Thus, the first guard surface 26, the cutting edges 10, 11, 12 of the blades 7, 8, 9 and the first cap surface 29 lie at an upper face of the blade unit.

To the rear frame member 4 behind the lubricating strip 28 are spaced parallel bars 31, 32 which respectively define a second guard surface 33 and a second cap surface 34. Affixed to the head body 2 is an additional, auxiliary blade 36 having an elongate sharp cutting edge 37 disposed between the second guard and cap surfaces 33, 34 and directed generally away from the upper face of the blade unit, the second guard and cap surfaces 33, 34 and the cutting edge 37 of the additional blade 36 lying at a rear face of the blade unit. The width of the area of the second guard surface 33 which contacts the skin when shaving with the additional blade 36 is substantially narrower than the width of the area of first guard surface 26 which contacts the skin when shaving with the blades 7, 8, 9. Similarly the width of the skin contact area of the second cap surface 34 is narrower than that of the first cap surface 29. As a result the blade unit 1 contacts the skin over a much smaller area when shaving with the additional blade 36 at the rear face of the blade unit than it does when shaving with the blades 7, 8, 9 at the upper face, and the rear face of the blade unit can be used to shave easily areas where access is restricted by adjacent facial features such as directly under the nostrils. Additional blade 36 is located in a plane at an angle of 60° to 120° (preferably 85° to 95°) to a plane of said plurality of shaving blades, and said additional blade being located at a same side of said head body as the plurality of shaving blades relative to the pivoting action centerline.A

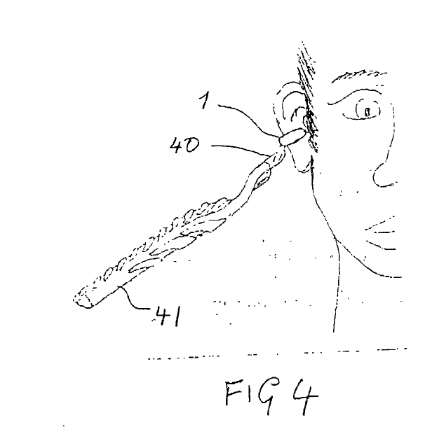

The blade unit 1 is adapted to be mounted pivotally on a support structure 40 connected to a handle 41 so the blade unit can pivot about an axis A parallel with the cutting edges 10, 11, 12 of the blades 7, 8, 9 and forwardly thereof. The support structure 40 is, conveniently as that described in WO 97/37819, the contents of which are incorporated herein by reference, there being a pair of yoke arms 42 with free ends engaged in journal sockets 43 formed in the frame ends 5, 6 on the underside of the blade unit frame 2. The sockets 43 define stops 44 which are arranged to abut against the arms of the support structure 40 to define an end position limiting the range of pivotal movement of the blade unit 1 relative to the supporting structure 40 and handle 41. A return spring mechanism (not shown) is provided to bias the blade unit 1 into the end position. When shaving with the blades 7, 8, 9, the forces exerted thereon tend to pivot the blade unit 1 about the pivoting action centerline A away from the end position and against the spring bias whereby the blade unit 1 is able to follow the skin contours while performing a shaving stroke, in a manner known per se. By rotating the razor handle through 180° from the position in which it is normally held for shaving with the blades 7, 8, 9, those blades are moved out of position for shaving and the further blade 36 is brought into an operative shaving position, such as for shaving under the nose, or for trimming hair in front of the ears as shown in FIG. 4. When shaving with the further blades 36, the load applied by the razor user acts to urge the stops 44 into firmer abutment with arms 42 of the support structure 40 effectively locking the blade unit 1 against pivotal movement about the axis A and enabling the user easily to position the blade accurately at the skin area to be shaved and to apply as much force as may be desired for shaving the area in question.

Modifications to the desired embodiment are of course possible without departing from the principles of the invention. By way of example is mentioned that:—

a) Two or more than three blades may be provided with cutting edges at the upper face of the blade unit;

b) More than one further blade with a cutting edge at the rear face can be provided;

c) The further blade or blades may be movably mounted in the blade unit, e.g. as the blades 7, 8, 9 are movably mounted in the described embodiment;

d) The second guard surface can be provided with an elastomeric strip and this strip could have upstanding fins or other projections for interaction with the skin and/or hairs; and

e) The second cap surface may have a shaving aid strip for applying a shaving aid substance, such as a lubricant, to the skin surface.

It is to be understood, therefore, that the specifically described embodiment is given by way of non-limiting example only and it is intended that the invention should be limited only by the claims which follow.

What is claimed is:

1. A multi-blade shaving apparatus comprising:
a handle;
a head body pivotably supported by said handle at a pivoting action centerline;
a plurality of shaving blades located in said head body, said plurality of shaving blades extending parallel to each other; and
an additional blade located in said head body, said additional blade being located in a plane at an angle of 60° to 120° to a plane of said plurality of shaving blades, and said additional blade being located at a same side of said head body as the plurality of shaving blades relative to the pivoting action centerline.

2. The multi-blade shaving apparatus according to claim 1, wherein there are three of said plurality of shaving blades.

3. The multi-blade shaving apparatus according to claim 1, wherein said plurality of shaving blades and said additional blade are identical in shape when secured to the shaving apparatus.

4. The multi-blade shaving apparatus according to claim 1, further comprising means for rotating the shaving apparatus to enable different of said plurality of shaving blades to be in contact with skin of a user dependent upon rotation of said handle.

5. The multi-blade shaving apparatus according to claim 1, said apparatus further comprising a rest position stop for eliminating pivoting of said handle when said additional blade is in use.

6. The multi-blade shaving apparatus according to claim 1, wherein said angle is between 85° to −95°.
